(19) United States
(12) Patent Application Publication
(10) Pub. No.: US 2019/0087086 A1
(43) Pub. Date: Mar. 21, 2019

(54) METHOD FOR PROVIDING COGNITIVE SEMIOTICS BASED MULTIMODAL PREDICTIONS AND ELECTRONIC DEVICE THEREOF

(71) Applicant: Samsung Electronics Co., Ltd., Suwon-si (KR)

(72) Inventors: Barath Raj KANDUR RAJA, Bangalore (IN); Arko SABUI, Dhanbad (IN); Ayan PAUL, Kolkata (IN); Ketki Aniruddha GUPTE, Nagpur (IN); Himanshu ARORA, Alwar (IN); Vibhav AGARWAL, Pilani (IN); Yellappa DAMAM, Bangalore (IN)

(21) Appl. No.: 16/116,594

(22) Filed: Aug. 29, 2018

(30) Foreign Application Priority Data
Aug. 29, 2017 (IN) 2017 41030547
Aug. 21, 2018 (IN) 201741030547

(51) Int. Cl. G06F 3/0488; G06F 17/27; G06N 5/02

(52) U.S. Cl. CPC G06F 3/04886; H04L 51/04; G06N 5/02; G06F 17/27

(57) ABSTRACT

A method for providing context based multimodal predictions in an electronic device is provided. The method includes detecting an input on a touch screen keyboard displayed on a screen of the electronic device. Further, the method includes generating one or more context based multimodal predictions based on the detected input from a language model. Furthermore, the method includes displaying the one or more context based multimodal predictions in the electronic device. An electronic device includes a processor configured to detect an input through a touch screen keyboard displayed on a screen of the electronic device, generate one or more context based multimodal predictions in accordance with the detected input from a language model, and cause the screen to display the one or more context based multimodal predictions in the electronic device.

### CROSS-REFERENCE TO RELATED APPLICATION

This application is based on and claims priority under 35 U.S.C. § 119 of an Indian patent application number 201741030547, filed on Aug. 29, 2017, in the Indian Intellectual Property Office and Indian patent application number 201741030547, filed on Aug. 21, 2018, in the Indian Intellectual Property Office, the disclosures of which are incorporated by reference herein in its entirety.

### BACKGROUND

### 1. Field

The present disclosure relates to electronic devices. More particularly it is related to a method and electronic device for providing cognitive semiotics based multimodal predictions.

### 2. Description of the Related Art

In general, electronic devices dominate all aspects of modem life. Over a period of time, the manner in which the electronic devices display information on a user interface has become intelligent, efficient, and less obtrusive.

The electronic devices such as for example, a mobile phone, a portable game console or the like provides a user interface that includes an on-screen keyboard which allows a user to enter input (i.e., a text) into the user interface by touching virtual keys displayed on a touch screen display. Further, various electronic messaging systems allow users to communicate with each other using one or more different types of communication media, such as text, emoticons, icons, images, video, and/or audio. Using such electronic methods, many electronic messaging systems allow users to communicate quickly with other users.

Electronic messaging systems that include the ability to send text messages allow a sender to communicate with other users without requiring the sender to be immediately available to respond. For example, instant messaging, SMS messaging, and similar communication methods allow a user to quickly send a text message to another user that the recipient can view at any time after receiving the message. Additionally, electronic messaging systems that allow users to send messages including primarily text also use less network bandwidth and storage resources than other types of communication methods.

Basic predictive text input solutions have been introduced for assisting with input on an electronic device. These solutions include predicting which word a user is entering and offering a suggestion for completing the word. But these solutions can have limitations, often requiring the user to input most or all of the characters in a word before the solution suggests the word the user is trying to input.

In some conventional methods for instant messaging, the methods often include some limitations that the recommendation modules and relevance modules in the electronic device does not extract the typography, multimodal contents (e.g., ideograms, texts, images, GIFs, semiotics etc.) of input provided by a user for instant messaging. Further, these methods do not automatically predict the next set of multimodal contents for the user based on the previous multimodal contents which are provided by the user.

The above information is presented as background information only to help the reader to understand the present invention. Applicants have made no determination and make no assertion as to whether any of the above might be applicable as Prior Art with regard to the present application.

### SUMMARY

Aspects of the disclosure are to address at least the above-mentioned problems and/or disadvantages and to provide at least the advantages described below.

Accordingly, an aspect of the disclosure is to provide a method and electronic device for providing cognitive semiotics based multimodal predictions.

Another aspect of the disclosure is to generate one or more context based multimodal predictions in accordance with a detected input from a language model.

Another aspect of the disclosure is to display one or more context based multimodal predictions in the electronic device.

Another aspect of the disclosure is to perform one or more actions in accordance with the detected input from a user.

Another aspect of the disclosure is to extract one or more semiotics in the language model in accordance with the user input.

Another aspect of the disclosure is to generate one or more context based multimodal predictions based on the one or more semiotics in the language model.

Another aspect of the disclosure is to modify a layout of a touch screen keyboard for a subsequent input based on the detected input.

Another aspect of the disclosure is to provide multimodal predictions by applying rich text aesthetics based on the context of the detected input.

Another aspect of the disclosure is to provide one or more semiotic predictions in response to a received message.

Another aspect of the disclosure is to prioritize the one or more context based multimodal predictions based on the one or more semiotics in the language model.

Additional aspects will be set forth in part in the description which follows and, in part, will be apparent from the description, or may be learned by practice of the presented embodiments.

In accordance with an aspect of the disclosure, a method for providing context based multimodal predictions in an electronic device. The method includes detecting an input on a touch screen keyboard displayed on a screen of the electronic device. Further, the method includes generating one or more context based multimodal predictions in accordance with the detected input from a language model. Furthermore, the method includes displaying the one or more context based multimodal predictions in the electronic device.

In accordance with an aspect of the disclosure, the input comprises at least one of a text, a character, a symbol and a sequence of words.

In accordance with an aspect of the disclosure, the context based multimodal predictions comprises at least one of graphical objects, ideograms, non-textual representations, words, characters and symbols.

In accordance with an aspect of the disclosure, the method includes performing one or more actions in accordance with the detected input.

In accordance with an aspect of the disclosure, the one or more actions include modifying a layout of the touch screen keyboard for a subsequent input based on the detected input.

In accordance with an aspect of the disclosure, the one or more actions in accordance with the detected input includes at least one of providing rich text aesthetics based on the context of the detected input, switching the layout of the keyboard while detecting the user input, predicting one or more characters based on the context of the detected input, capitalizing one or more characters or one or more words based on the context of the detected input and recommending one or more suggestions in accordance with the user input, providing one or more semiotic predictions in response to a received message and understanding text with punctuations.

In accordance with an aspect of the disclosure, generating the one or more context based multimodal predictions in accordance with the detected input from the language model includes analyzing the detected input with one or more semiotics in the language model. The method includes extracting the one or more semiotics in the language model in accordance with the user input. The method includes generating the one more context based multimodal predictions based on the one or more semiotics in the language model. Further, the method includes feeding the one or more semiotics to the language model after the input for predicting next set of multimodal predictions.

In accordance with an aspect of the disclosure, the language model includes representations of the multimodal predictions with semiotics data corresponding to a text obtained from a plurality of data sources. The semiotics data is classified based on a context associated with the text.

In accordance with an aspect of the disclosure, each text obtained from the plurality of data sources is represented as semiotics data in the language model for generating the one or more context based multimodal predictions.

In accordance with an aspect of the disclosure, the one or more context based multimodal predictions are prioritized based on the one or more semiotics in the language model.

In accordance with another aspect of the disclosure, the disclosure provides a method for providing context based multimodal predictions in an electronic device. The method includes generating a language model containing semiotics data corresponding to a text obtained from a plurality of data sources. The method includes detecting an input on a touch screen keyboard displayed on a screen of the electronic device. Further, the method includes generating one or more context based multimodal predictions in accordance with the detected input from the language model. Furthermore, the method includes displaying the one or more context based multimodal predictions in the electronic device.

In accordance with another aspect of the disclosure, the disclosure provides an electronic device for providing context based multimodal predictions. The electronic device includes a multimodal prediction module configured to detect an input on a touch screen keyboard displayed on a screen of the electronic device. The multimodal prediction module configured to generate one or more context based multimodal predictions in accordance with the detected input from a language model. The multimodal prediction module configured to display the one or more context based multimodal predictions in the electronic device.

In accordance with another aspect of the disclosure, the disclosure provides an electronic device for providing context based multimodal predictions. The electronic device includes a language model generation module and a multimodal prediction module. The language model generation module configured to generate a language model containing semiotics data corresponding to a text obtained from a plurality of data sources. The multimodal prediction module configured to detect an input on a touch screen keyboard displayed on a screen of the electronic device. The multimodal prediction module configured to generate one or more context based multimodal predictions in accordance with the detected input from the language model. Further, the multimodal prediction module configured to display the one or more context based multimodal predictions in the electronic device.

Other aspects, advantages, and salient features of the disclosure will become apparent to those skilled in the art from the following description, which, taken in conjunction with the annexed drawings, discloses various embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

The above and other aspects, features, and advantages of certain embodiments of the disclosure will be more apparent from the following description taken in conjunction with the drawings, in which:

FIGS. 1A-1C are example illustrations for providing context based multimodal predictions, according to various embodiments of the disclosure;

FIG. 2A is an exemplary block diagram of an electronic device, according to an embodiment of the disclosure;

FIG. 2B illustrates exemplary various steps performed by a language model generation module in the electronic device, according to an embodiment of the disclosure;

FIG. 2C illustrates exemplary various components of a multimodal prediction module, according to an embodiment of the disclosure;

FIG. 2D illustrates exemplary various components of a multimodal prediction module 120, according to an embodiment of the disclosure;

FIG. 3 is an exemplary flow chart illustrating a method for providing context based multimodal predictions in the electronic device, according to an embodiment of the disclosure;

FIG. 4 is an exemplary flow chart illustrating a method for generating context based multimodal predictions in accordance with an input detected from a user, according to an embodiment of the disclosure;

FIGS. 5A and 5B are example illustrations in which semantic typography is provided based on the detected input from the user, according to various embodiments of the disclosure;

FIGS. 6A-6F are example illustrations in which a layout of a touch screen keyboard is modified in accordance with the detected input, according to various embodiments of the disclosure;

FIGS. 7A and 7B are example illustrations in which character(s) are predicted in accordance with the input, according to various embodiment of the disclosure;

FIGS. 8A and 8B are example illustrations in which words are capitalized automatically, according to various embodiment of the disclosure;

FIGS. 9A and 9B are example illustrations in which predictions are provided based on the context of the detected input, according to various embodiments of the disclosure;

FIGS. 10A and 10B are example illustrations in which predictions are provided during a continuous input event on the touch screen keyboard, according to various embodiments of the disclosure;

FIG. 11 is an example illustration for word prediction based on the detected input, according to an embodiment of the disclosure; and

FIG. 12 is an example illustration in which a response to a received message is predicted at the electronic device, according to an embodiment of the disclosure.

Throughout the drawings, it should be noted that like reference numbers are used to depict the same or similar elements, features, and structures.

### DETAILED DESCRIPTION

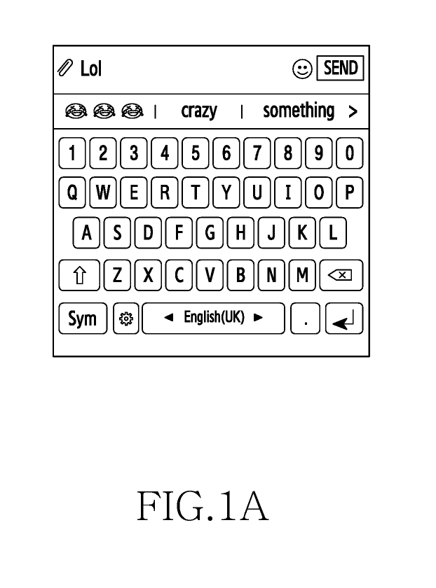

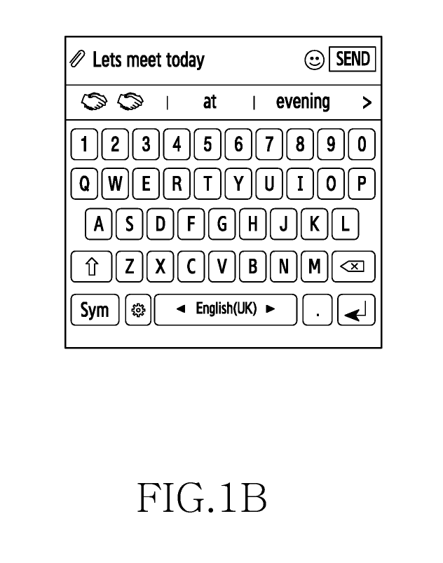

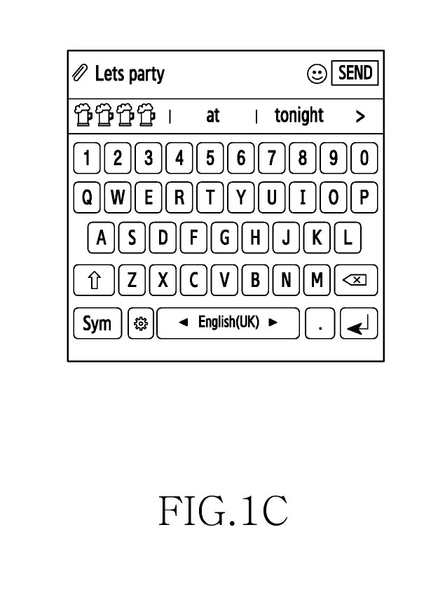

FIGS. 1A through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skilled in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments described herein are not necessarily mutually exclusive, as some embodiments can be combined with one or more other embodiments to form new embodiments.

The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units, modules, manager, modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The embodiments herein provide a method for providing context based multimodal predictions in an electronic device. The method includes detecting an input on a touch screen keyboard displayed on a screen of the electronic device. Further, the method includes generating one or more context based multimodal predictions in accordance with the detected input from a language model. Furthermore, the method includes displaying the one or more context based multimodal predictions in the electronic device.

In some embodiments, the method includes generating a language model containing semiotics data corresponding to a text obtained from a plurality of data sources. The information/knowledge/text obtained from the plurality of data sources is represented as semiotics data in the language model and the semiotics data is classified based on a context associated with the text. The language model with semiotics data can be generated at the electronic device or can be generated external to the electronic device (i.e., for example at a server).

The method and system may be used to provide cognitive semiotics based multimodal predictions in the electronic device. With the method, multimodal content in the data corpus collected from various sources is interpreted. The data corpus includes web data (such as Blogs, Posts and other website crawling) as well as user data (such as SMS, MMS, and Email data). The data is represented as at least one semiotic for the at least one multimodal content by processing or representing the data corpus with rich annotation.

The method includes generating a tunable semiotic language model on the processed data corpus, preloading the language model in the electronic device for predicting the multimodal content while the user is typing or before the user is composing the multimodal content Furthermore, the method includes generating a user language model dynamically in the electronic device from the user typed data.

Referring now to the drawings and more particularly to FIGS. 1A through 13, where similar reference characters denote corresponding features consistently throughout the figures, there are shown preferred embodiments.

FIGS. 1A-IC are example illustrations for providing context based on multimodal predictions, according to various embodiments of the disclosure. Referring to FIG. 1A, when the user inputs a text ‘LoL’, the electronic device generates context based multimodal predictions. The multimodal predictions are multiple possible suggestions based on an input from the user. The multimodal predictions include a combination of graphical objects, ideograms, non-textual representations, words, characters and symbols. For example, as shown in the FIG. 1A, when the user inputs the text ‘Lol’, the electronic device provides the multimodal predictions such as three ‘emojis’ (i.e., emoticons), ‘crazy’ and ‘something.’ Thus, the multimodal predictions include both textual and non-textual predictions.

Referring to FIG. 1B, when the user inputs the text ‘Lets meet today,’ the electronic device 100 generates the multimodal predictions such as ideograms representing two handshake symbols, ‘at’ and ‘evening’ based on the user input. Thus, the multimodal predictions generated by the electronic device include both textual and non-textual predictions.

Referring to FIG. 1C, when the user inputs a text as ‘Lets party,’ the electronic device generates multimodal predictions such as ideograms representing ‘four beers,’ ‘at’ and ‘tonight’ based on the user input. Thus, the multimodal predictions generated by the electronic device include a combination of textual and non-textual predictions.

The FIGS. 1A-1C illustrates only few embodiments of the present disclosure. It is to be understood that the other embodiments are not limited thereto. The various embodiments are illustrated in conjunction with figures in the later parts of the description.

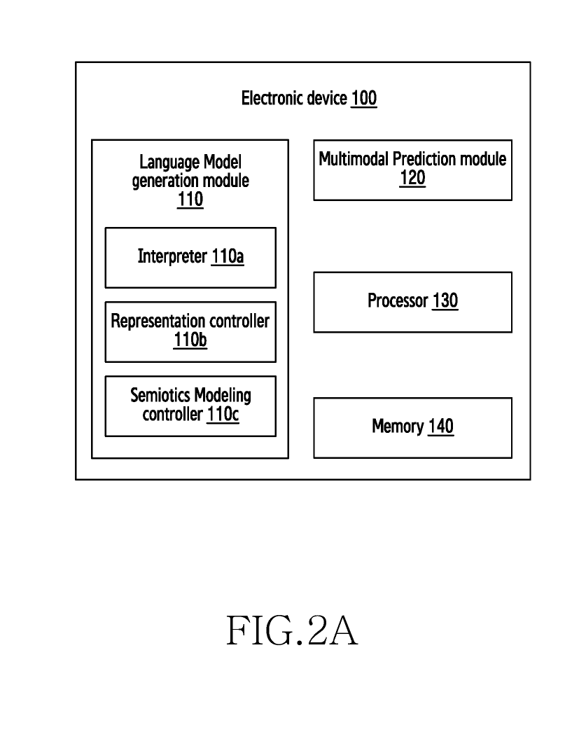

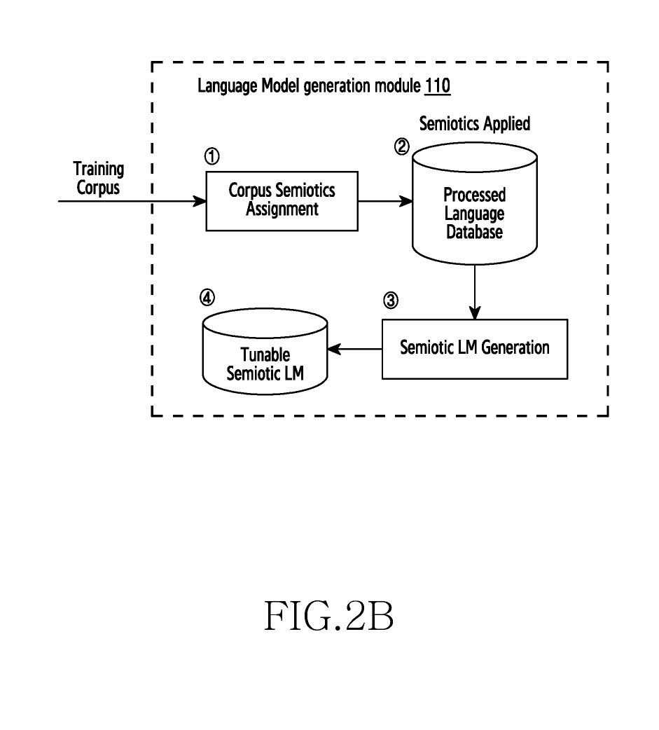

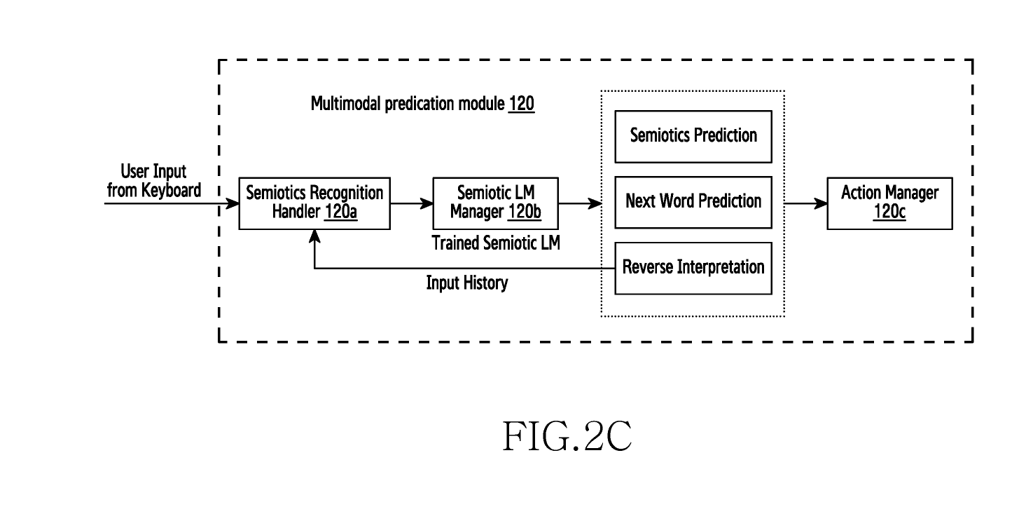

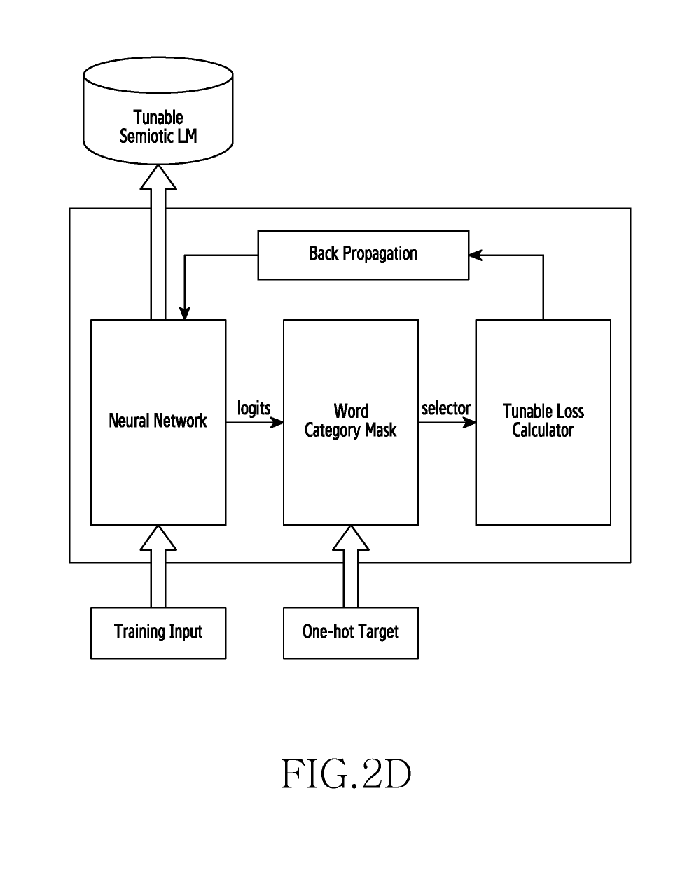

FIG. 2A is a block diagram of an electronic device 100, according to an embodiment of the disclosure. The electronic device 100 can be, for example, but not limited to a cellular phone, a smart phone, a server, a Personal Digital Assistant (PDA), a tablet computer, a laptop computer, a smart watch, a smart glass or the like.

Referring to FIG. 2A, the electronic device 100 includes a language model generation module 110, a multimodal prediction module 120, a memory 130, a processor 140 and a display screen 150.

In the FIG. 2A, the language model generation module 110 is shown in the electronic device 100, and the language model generation module 110 may be external to the electronic device 100. For example, the language model generation is performed in a server. Thus, the language model generation may be performed either at the electronic device 100 or at the server.

The language model generation module 110 includes an interpreter 110a, a representation controller 110b and a semiotics modeling controller 110c.

In an embodiment, the interpreter 110a may be configured to extract knowledge, information, text or the like from a plurality of data sources. The knowledge, information and text include natural language text, sentences, words, phrases or the like. In an example, the interpreter 110a may be configured to extract the knowledge and patterns of various multimodal contents such as ideograms, text, image, GIFs etc. in the text obtained from the plurality of data sources which includes for example, Blogs, websites, SNS posts) and user data (including, SMS, MMS, Email), along with multimodal contents.

In an embodiment, the representation controller 110b may be configured to represent the knowledge, information and text obtained from the plurality of data sources to corresponding semiotics data. Each text obtained from the plurality of data sources is converted to semiotics data. The representation controller 110b may be configured to identify the semiotics for the multimodal contents.

The representation controller 110b converts each text to semiotics data. An example illustration of the text which is converted to semiotics data is shown in the below table.

| Text | Semiotics Data |
|---|---|
| Lets party [symbol] [symbol] [symbol] [symbol] | Lets party <4E_BEER> |
| Congrats on 7th Anniversary | Congrats on <I_NT> Anniversary |
| Email me at sam@s.com | Email me at <EMAIL> |
| Lets meet at 8.00 AM | Lets meet at <TIME> AM |
| Will come on 22 May 2017 | Will come on <DATE> |

In an embodiment, the representation controller 110b processes and understands Typography, Quantity, Multimodal content (Ideograms, Text, Image, Gif, Voice, etc.) for representing the semiotics data. The representation controller 110b processes the text with Rich Annotations.

The semiotics modeling controller 110c processes semiotic data set. In some embodiments, the semiotics modeling controller 110c may be configured to prioritize the semiotics data in the semiotic data set. Thus, the semiotics modeling controller 110c generates the language model by processing and tuning the semiotics data.

In an embodiment, the multimodal prediction module 120 may be configured to generate context based multimodal predictions in accordance with the detected input from a language model. The multimodal prediction module 120 may be configured to communicate with language model generation module 110 to identify semiotics data corresponding to the detected input in the language model.

In an embodiment, the multimodal prediction module 120 may be configured to analyze the detected input with one or more semiotics in the language model. Further, the multimodal prediction module 120 may be configured to extract the semiotics data in the language model in accordance with the user input. After extracting the semiotics data in the language model, the multimodal prediction module 120 may be configured to generate the context based multimodal predictions based on the one or more semiotics in the language model.

The processor 130 is coupled with the multimodal prediction module 120, and the memory 140. The processor 130 is configured to execute instructions stored in the memory 140 and to perform various actions for providing the context based multimodal predictions. The memory 140 also stores instructions to be executed by the processor 130. The memory 140 may include non-volatile storage elements.

Although the FIG. 2A shows various hardware components of the electronic device 100, it is to be understood that other embodiments are not limited thereon. In other embodiments, the electronic device 100 may include less or more number of components. Further, the labels or names of the components are used only for illustrative purpose and does not limit the scope of the invention. One or more components may be combined together to perform same or substantially similar function to perform context based on actions in the electronic device 100.

FIG. 2B illustrates various steps performed by a language model generation module 110 in the electronic device 100, according to an embodiment of the disclosure. Initially, the knowledge, information and text obtained from the plurality of data sources is used for training the language model generation module 110. Referring to FIG. 2B, at step 1, semiotics is assigned to each text obtained from the plurality of data sources. At step 2, the semiotics data corresponding to the text is stored in a processed language database. At step 3, the language model is generated with the semiotics data representing the text. Further, at step 4, the language model is tuned by assigning appropriate weights for prioritizing the multimodal predictions.

FIG. 2C illustrates various components of a multimodal prediction module 120, according to an embodiment of the disclosure. Referring to FIG. 2C, the multimodal prediction module 120 includes a semiotics recognition handler 120a, semiotics language model manager 120b and an action manager 120c. The multimodal prediction module 120 may be configured to detect the input text from the user through the touch screen keyboard.

When the user input the text in the electronic device 100, the semiotics recognition handler 120a interprets the multimodal contents of the texts and identifies the semiotics associated with the multimodal contents. Further, the semiotics are stored in the semiotic language modeling manager 120b to predict the next semiotics, next words and generating reverse interpretation. The action manager 120c may be configured to perform one or more actions to display the predicted multimodal content on the user interface of the electronic device 100.

In an embodiment, the action manager 120c may be configured to perform one or more actions which include modifying the layout of the touch screen keyboard, providing rich text aesthetics, predicting ideograms, capitalizing words automatically or the like. The various actions performed by the action manager 120c are described in conjunction with figures in the later parts of the description.

FIG. 2D illustrates a tunable semiotic language model, according to an embodiment of the disclosure. The semiotic language model may be tuned for prioritizing the context based multimodal predictions. Referring to FIG. 2D, a neural network detects a training input from the user and transfers it to a word category mask, with which the selector performs calculations using tunable loss calculator.

Further, if the calculation is based on loss, then it is propagated back to the neural network and if there is no loss the tunable semiotics are stored in tunable semiotics language modeling as shown in the FIG. 2D.

Herein, the selector may be represented as a vector.

selectorc=mc*yi Equation (1)

where me is the mask vector for a certain category c (c may be rich text, hypertext, special time and date semiotics and so on) and yi is the i-th training target. The selector vector is C bits long if the total number of categories of semiotics/words is C. Dot product between 2 vectors is represented by *.

Further, a loss coefficient may be represented as:

lossCoefficient=selector*coefficientVector Equation (2)

where coefficientVector is the vector of non-zero coefficients for different categories of semiotics/words. In the trivial case, all elements of coefficientVector are 1. Tuning the coefficientVector allows us to model different categories of semiotics differently and this can even be set as a trainable parameter which would allow the training semiotic assigned corpus to dictate the coefficient terms.

Accordingly, the calculation based on loss may be represented as:

loss=Σᵢ₌₁^{N}(lossCoefficient*CE(yp,i,yi))/Σᵢ₌₁^{N}(lossCoefficient) Equation (3)

where * is simple product and CE is cross entropy loss and the embodiments in the disclosure are considering N training examples.

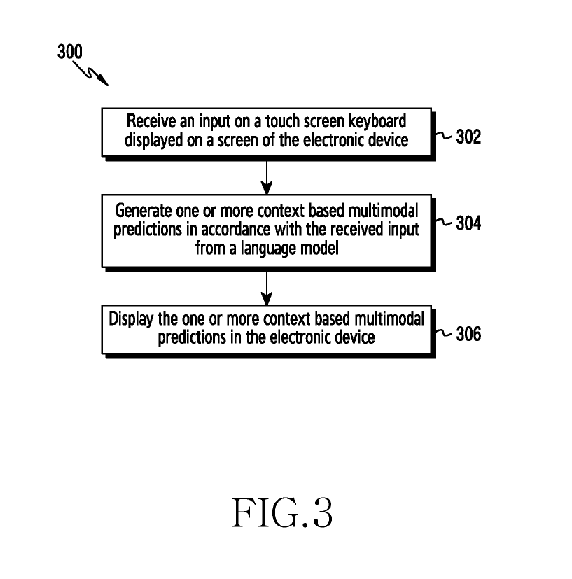

FIG. 3 is a flow chart 300 illustrating a method for providing context based multimodal predictions in the electronic device 100, according to an embodiment of the disclosure. Referring to FIG. 3, at step 302, the method includes detecting an input on a touch screen keyboard displayed on a screen of the electronic device 100. The method allows the multimodal prediction module 120 to detect the input on a touch screen keyboard displayed on a screen of the electronic device 100.

At step 304, the method includes generating one or more context based multimodal predictions in accordance with the detected input from the language model. The method allows the multimodal prediction module 120 to generate the one or more context based multimodal predictions in accordance with the detected input from the language model.

At step 306, the method includes displaying the one or more context based multimodal predictions in the electronic device 100. The method allows the multimodal prediction module 120 to display the more context based multimodal predictions in the electronic device 100. The various example illustrations in which the electronic device 100 provides context based multimodal predictions are described in conjunction with the figures.

The various actions, acts, blocks, steps, or the like in the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

Further, before the step 302, the method may include generating a language model containing semiotics data corresponding to a text obtained from a plurality of data sources. The method allows the language model generation module 110 to generate the language model containing semiotics data corresponding to a text obtained from a plurality of data sources.

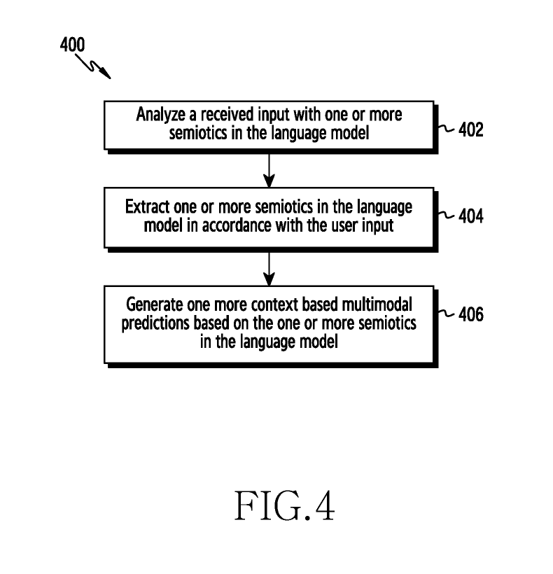

FIG. 4 is a flow chart 400 illustrating an exemplary method for generating context based multimodal predictions in accordance with an input detected from a user, according to an embodiment of the disclosure. Referring to FIG. 4, at step 402, the method includes analyzing a detected input with one or more semiotics in the language model. The method allows the multimodal prediction module 120 to analyze the detected input with one or more semiotics in the language model.

At step 404, the method includes extracting one or more semiotics in the language model in accordance with the user input. The method allows the multimodal prediction module 120 to extract the one or more semiotics in the language model in accordance with the user input.

At step 406, the method includes generating one more context based multimodal predictions based on the one or more semiotics in the language model. The method allows the multimodal prediction module 120 to generate the one more context based multimodal predictions based on the one or more semiotics in the language model. Further, the method includes feeding the semiotics data back to the language model after the user input, for predicting next set of multimodal predictions. The semiotics data is fed back to the language model after the user input, for predicting next set of multimodal predictions.

The various actions, acts, blocks, steps, or the like in the flow diagram 400 may be performed in the order presented, in a different order or simultaneously. Further, in some embodiments, some of the actions, acts, blocks, steps, or the like may be omitted, added, modified, skipped, or the like without departing from the scope of the invention.

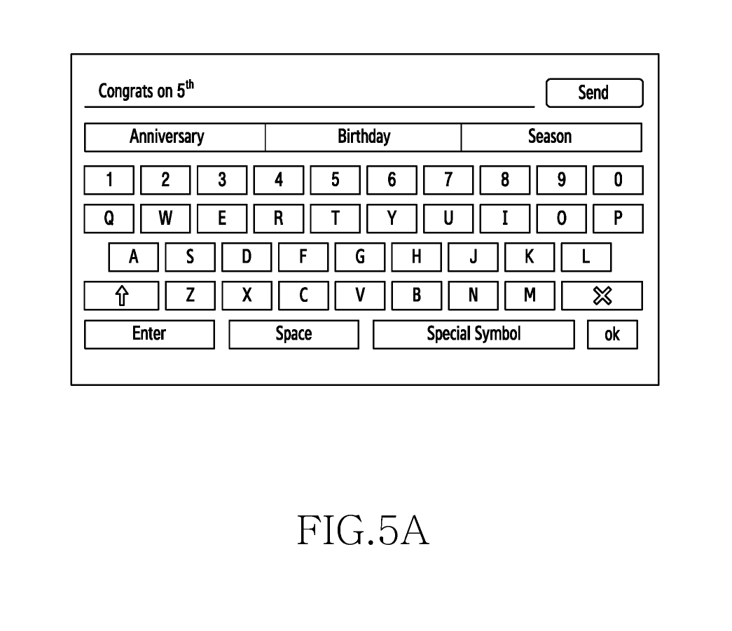

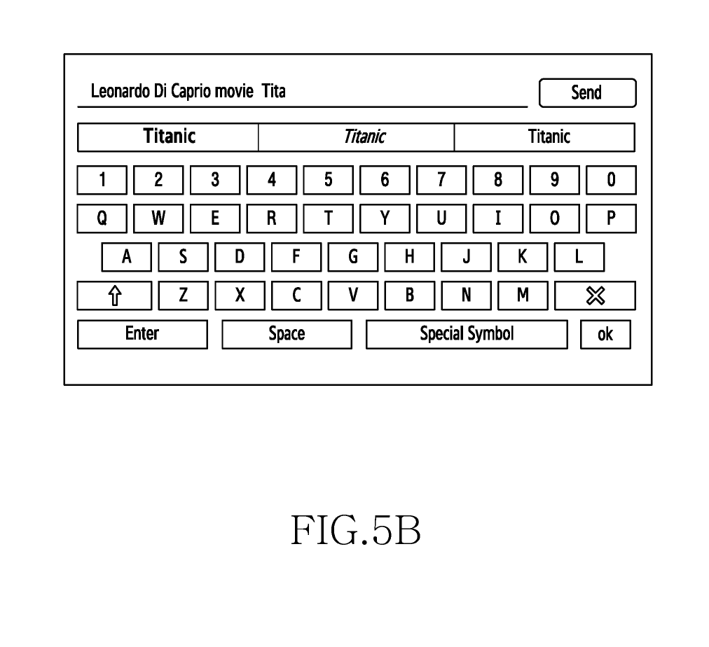

FIGS. 5A and 5B are example illustrations in which semantic typography is provided based on the detected input from the user, according to various embodiments of the disclosure. Referring to FIG. 5A, when the user inputs the text as ‘congrats on 5^{th},’ the multimodal prediction module 120 analyzes the user input with semiotics in the language model.

The multimodal prediction module 120 interprets the user input (e.g., congrats on 7th anniversary, congrats on 51st anniversary). Further, the multimodal prediction module 120 identifies the semiotic for the multimodal content (e.g., congrats on <I_NT> anniversary, congrats on <B_NT> anniversary) and generates a semiotics language modeling which is preloaded in the electronic device 100. When the user types a message (e.g., congrats on 5th), the multimodal prediction module 120 identifies the semiotics of the typed text (e.g., 5th to <NT>) and forwards the identified <NT> to the semiotics modeling controller 110c. Further, the multimodal prediction module 120 retrieves various multimodal predictions (e.g., <I_NT> anniversary) and displays it on the user interface of the electronic device 100. Thus, the multimodal prediction module 120 predicts the words ‘Anniversary’, Birthday’ and ‘Season’ based on the user input. The predictions are provided by applying rich text aesthetics. Thus, the predictions such as ‘Anniversary’, Birthday’ and ‘Season’ are provided as Bold and Italicized aesthetics as shown in the FIG. 5A.

Referring to FIG. 5B, when the user inputs text such as ‘Leonardo Di Caprio movie Tita’, the multimodal prediction module 120 identifies the semiotics of the typed text as <Italic_Text> (e.g., Leonardo Di Caprio movie’ to <Italic_Text>) and forwards the identified <Italic_Text> to the semiotics modeling controller 110c. Further, the multimodal prediction module 120 retrieves various multimodal predictions with “Italic” or “Bold” font. Thus, the multimodal prediction module 120 predicts the words such as ‘Titanic’ based on the user input. The predictions are provided by applying rich text aesthetics.

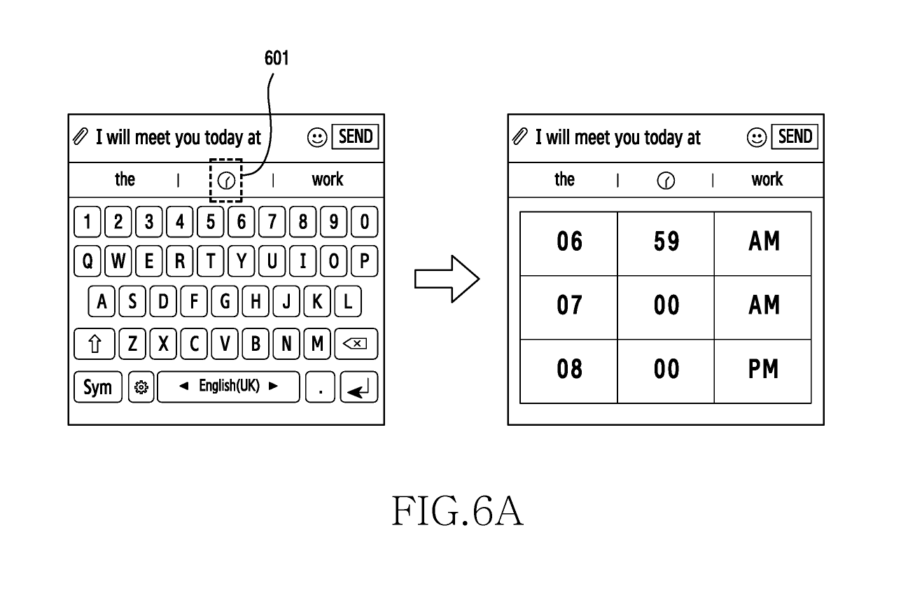

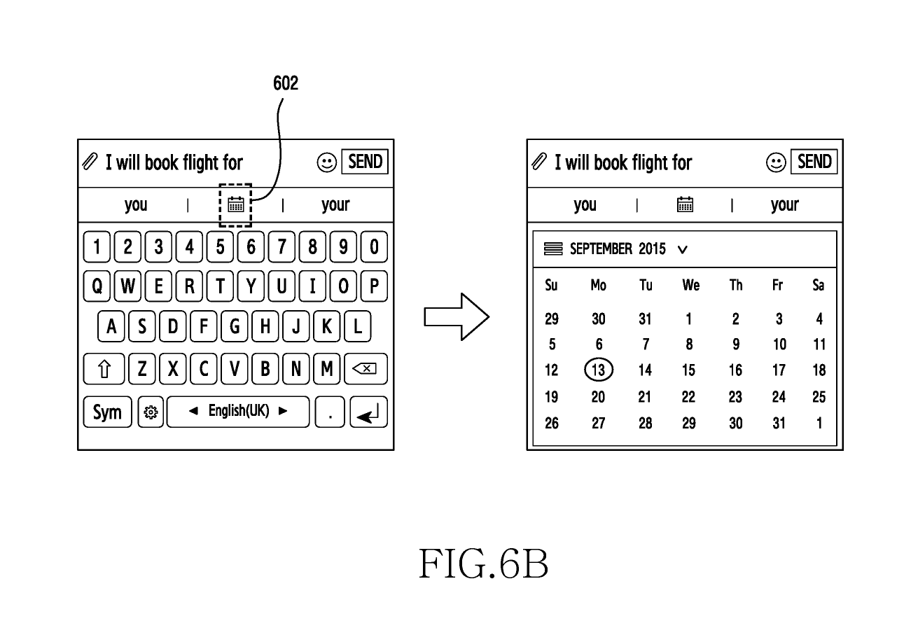

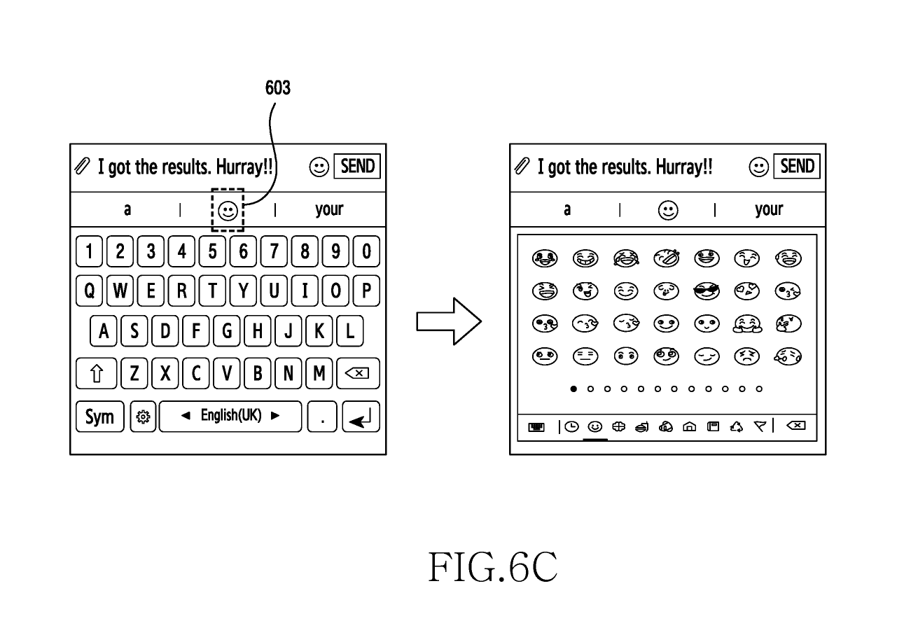

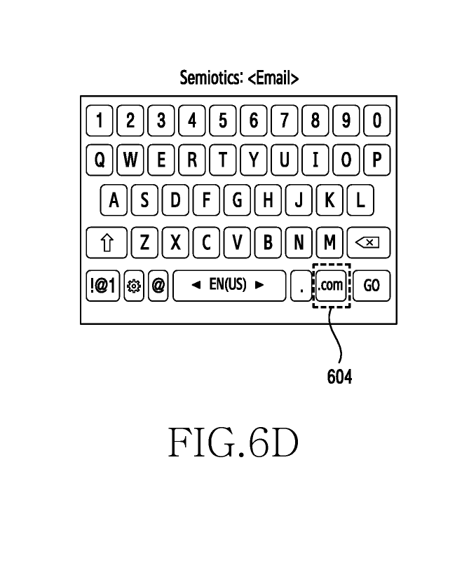

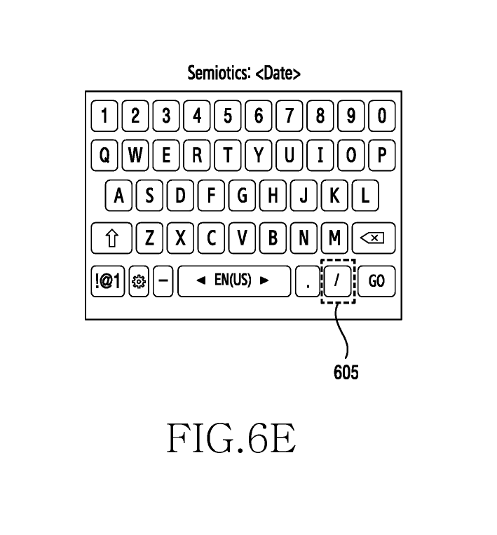

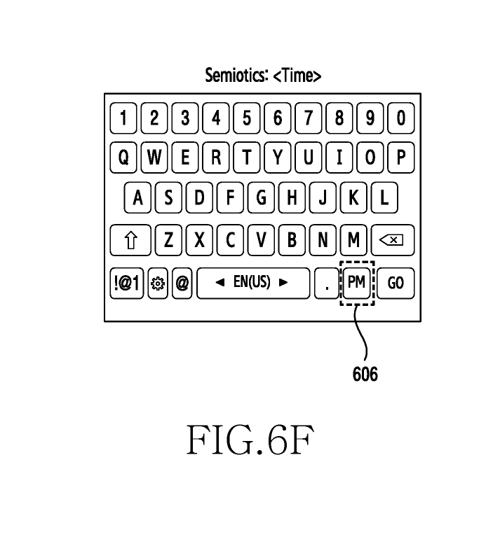

FIGS. 6A-6F are example illustrations in which a layout of a touch screen keyboard is modified in accordance with the detected input, according to various embodiments of the disclosure. Referring to FIG. 6A, the user enters the text ‘I will meet you at.’ The multimodal prediction module 120 analyzes the text with the semiotics in the language model. Further, the multimodal prediction module 120 predicts <time> as semiotic in the language model. At this time, a prediction such as a time icon 601 corresponding to <time> as semiotic in the language model may be provided. When a touch to the time icon 601 is detected, the multimodal prediction module 120 modifies the layout of the touch screen keyboard to enter the time.

Referring to FIG. 6B, the user enters the text ‘I will book a flight for.’ The multimodal prediction module 120 analyzes the text with the semiotics in the language model. Further, the multimodal prediction module 120 predicts <date> as semiotic in the language model based on the text detected from the user. At this time, a prediction such as a calendar icon 602 corresponding to <date> as semiotic in the language model based on the text detected from the user may be provided. When a touch to the calendar icon 601 is detected, the multimodal prediction module 120 modifies the layout of the touch screen keyboard to display a calendar. Thus, the multimodal prediction module 120 modifies the layout of the touch screen keyboard to allow the user to enter date, based on the context of the detected text from the user.

Referring to FIG. 6C, the user enters the text ‘I got the results Hurray.’ The multimodal prediction module 120 analyzes the text with the semiotics in the language model. Further, the multimodal prediction module 120 predicts emojis as semiotics in the language model based on the text detected from the user. At this time, a prediction such as a smile icon 603 corresponding to emojis as semiotic in the language model based on the text detected from the user may be provided. When a touch to the smile icon 603 is detected, the multimodal prediction module 120 modifies the layout of the touch screen keyboard to display multiple emojis. Thus, the multimodal prediction module 120 modifies the layout of the touch screen keyboard to allow the user to provide one or more emojis subsequent to the text provided by the user.

Referring to FIG. 6D, the multimodal prediction module 120 predicts <Email> as semiotics in the language model. At this time, the multimodal prediction module 120 modifies a part of the layout of the touch screen keyboard automatically. For example, the multimodal prediction module 120 adds ‘.com’ 604 to the layout of the touch screen keyboard.

Referring to FIG. 6E, the multimodal prediction module 120 predicts <Date> as semiotics in the language model. At this time, the multimodal prediction module 120 modifies a part of the layout of the touch screen keyboard automatically. For example, the multimodal prediction module 120 adds ‘/’ 605 to the layout of the touch screen keyboard.

Referring to FIG. 6F, the multimodal prediction module 120 predicts <Time> as semiotics in the language model. At this time, the multimodal prediction module 120 modifies a part of the layout of the touch screen keyboard automatically. For example, the multimodal prediction module 120 adds ‘PM’ 606 to the layout of the touch screen keyboard.

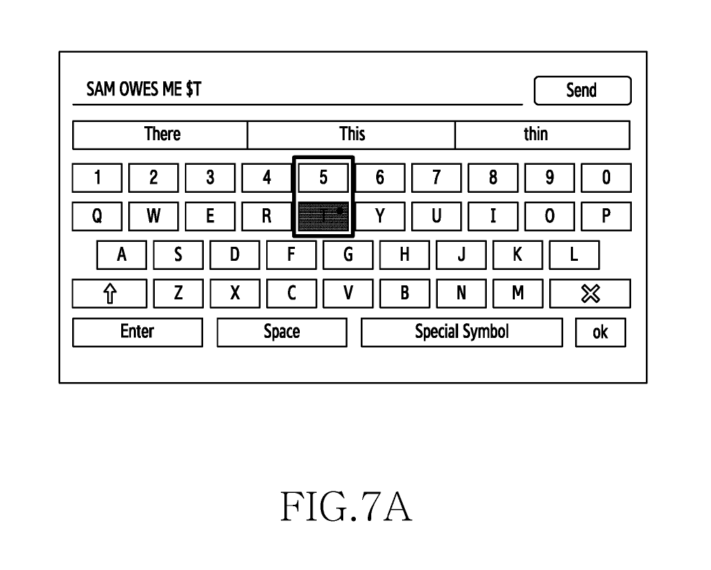

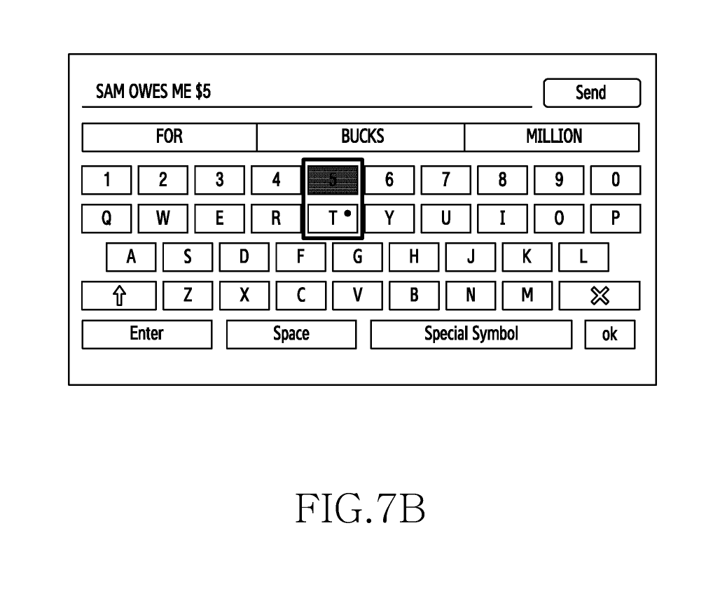

FIGS. 7A and 7B are example illustrations in which character(s) are predicted in accordance with the input, according to various embodiments of the disclosure.

Referring to FIG. 7A, the user enters text ‘SAM OWES ME $’ and taps on a fixed region corresponding to character ‘T’ and the character T is added to the text as ‘SAM OWES ME $T.’ Thus, in the conventional systems, although user has wrongly taps on the region a fixed region corresponding to character ‘T’ and the character T is added to the text.

Referring to FIG. 7B, the user enters text ‘SAM OWES ME $’ and taps on a fixed region corresponding to character ‘T,’ the multimodal prediction module 120 predicts key ‘5’ as composing word $ belongs to <Currency>/<C> Tag from the language model even though the user taps on the fixed region corresponding to character ‘T’. Further, the multimodal prediction module 120 predicts the words such as ‘FOR,’ ‘BUCKS’ and ‘MILLION’ based on the context of the text. Since <C> represents currency in the language model, when there is a conflict between a number and a character key, number key is prioritized. Thus, the method provides key prioritization and selection of character can be improved using the method.

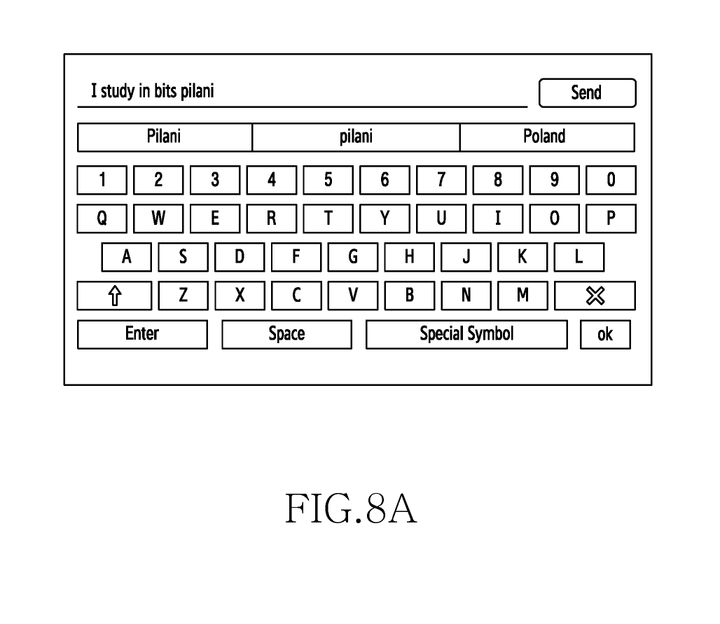

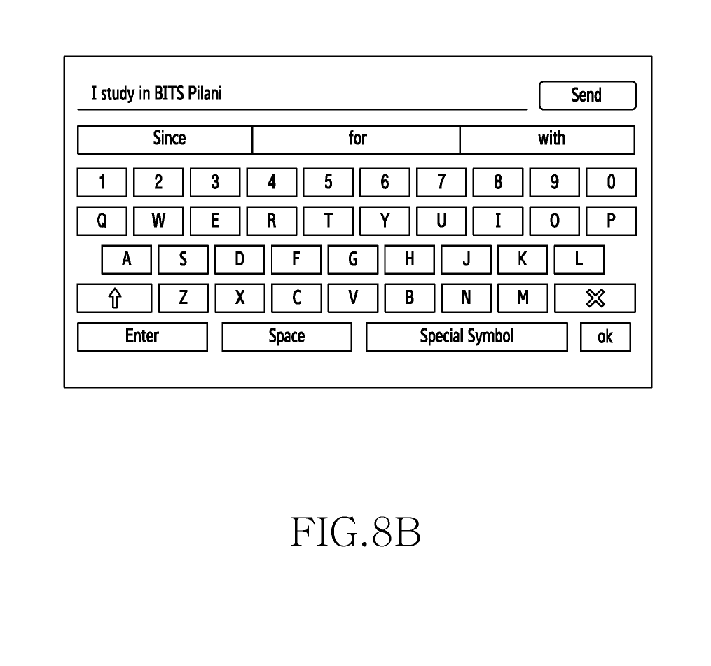

FIGS. 8A and 8B are example illustrations in which words are capitalized automatically, according to various embodiment of the disclosure. Referring to FIG. 8A, the user enters the text ‘I study in bits pilani.’ The multimodal prediction module 120 analyzes the text (i.e., characters in the text). The multimodal prediction module 120 determines whether the semiotics corresponding to the text exists in the language model. Further, the multimodal prediction module 120 automatically capitalizes nouns in the text (i.e., in the text bits pilani, bits is a noun). Thus, the multimodal prediction module 120 automatically capitalizes the word bits as BITS, when the user enters space through the touch screen keyboard as shown in the FIG. 8B. Further, the multimodal prediction module 120 predicts words such as ‘since,’ ‘for’ and ‘with’ based on the context of the text as shown in the FIG. 8B

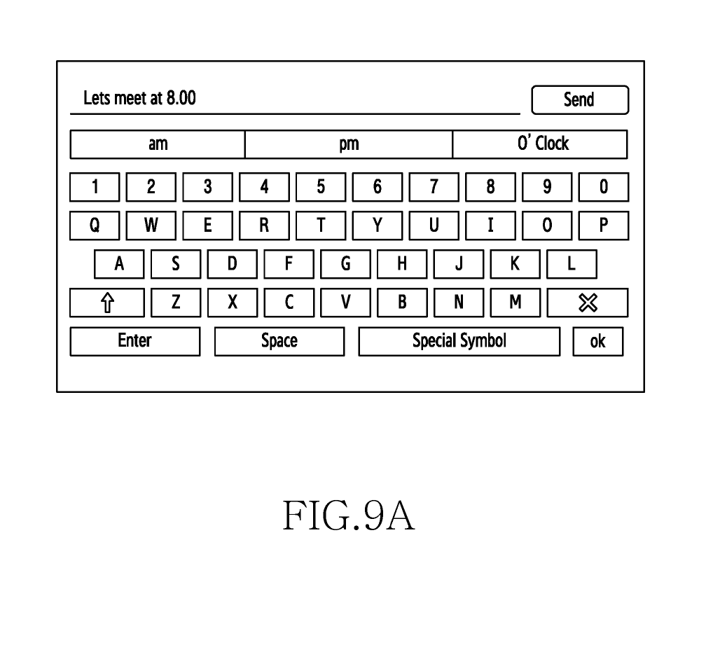

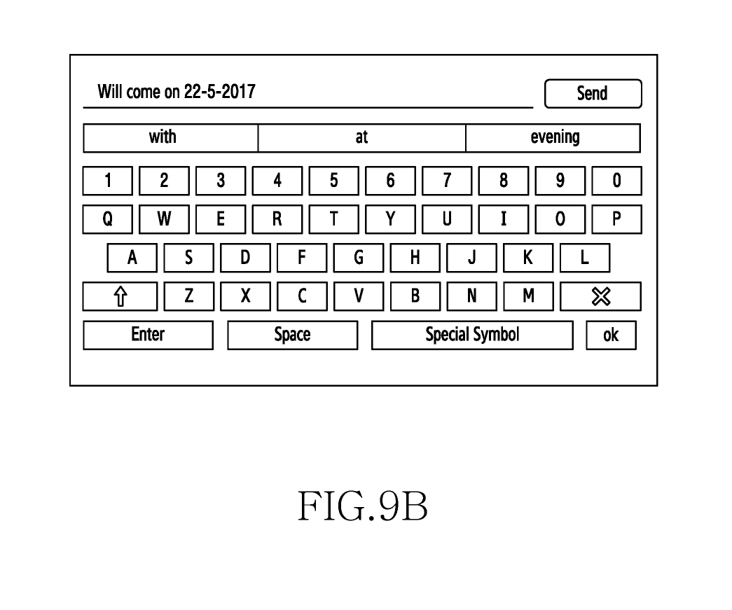

FIGS. 9A and 9B are example illustrations in which predictions are provided based on the context of the detected input, according to various embodiments of the disclosure. Referring to FIG. 9A, the user enters the text as ‘Let's meet at 8:00.’ The multimodal prediction module 120 analyzes the text with the semiotics in the language model. Further, the multimodal prediction module 120 predicts <time> as semiotic in the language model based on the text detected from the user. The multimodal prediction module 120 predicts ‘am’ ‘pm’ and ‘O’ clock based on the context of the text detected from the user. The multimodal prediction module 120 may be configured to understand the text and provides relevant predictions based on the context.

Referring to FIG. 9B, the user enters the text as ‘Will come on 22 May 2017.’ The multimodal prediction module 120 analyzes the text with the semiotics in the language model. Further, the multimodal prediction module 120 predicts <date> as semiotic in the language model based on the text detected from the user. The multimodal prediction module 120 predicts ‘with’ ‘at’ and ‘evening’ clock based on the context of the text detected from the user. Thus, the multimodal prediction module 120 may be configured to understand the text and provides relevant predictions based on the context.

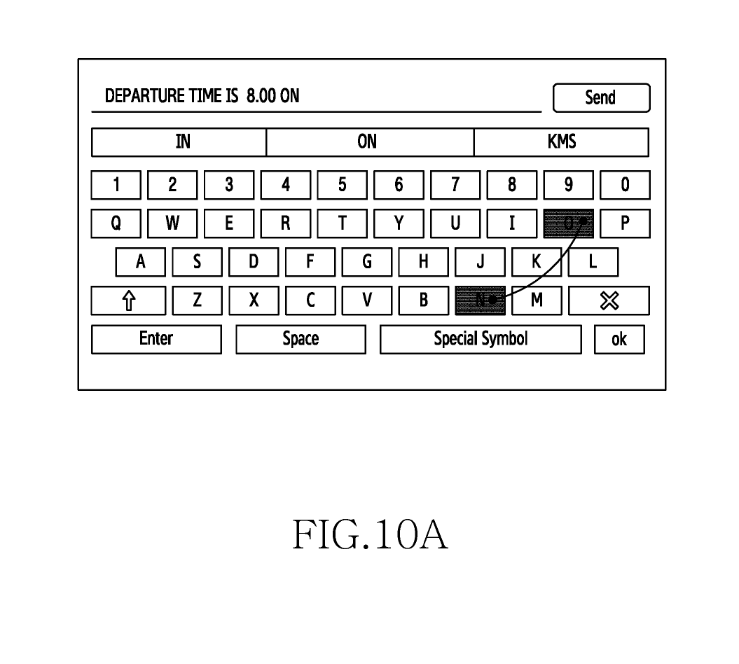

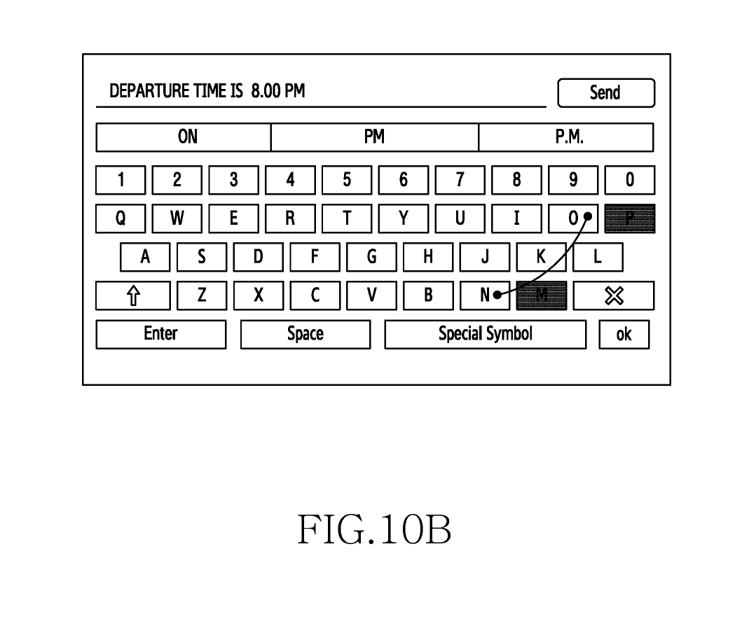

FIGS. 10A and 10B are example illustrations in which predictions are provided during a continuous input event on the touch screen keyboard, according to various embodiments of the disclosure. During the continuous input event, the user performs a swipe on the touch screen keyboard to enter the text. Referring to FIG. 10A, the user enters text as ‘DEPARTURE TIME IS 8:00’ and performs swipe from ‘O’ to ‘N.’ When the user swipes from ‘O’ to ‘N,’ then the text is entered as ‘DEPARTURE TIME IS 8:00 ON which is not intended by the user.

With the above described method, when the user swipes from ‘O’ to ‘N,’ the multimodal prediction module 120 identifies the semiotics classified as <Time> in the language model. Thus, the multimodal prediction module 120 predicts PM, even though the user swipes from ‘O’ to ‘N.’. Thus, the multimodal prediction module 120 provides the text as DEPARTURE TIME IS 8:00 PM as shown in the FIG. 10B. With the method, the accuracy of predictions may be improved during continuous input events on the touch screen keyboard.

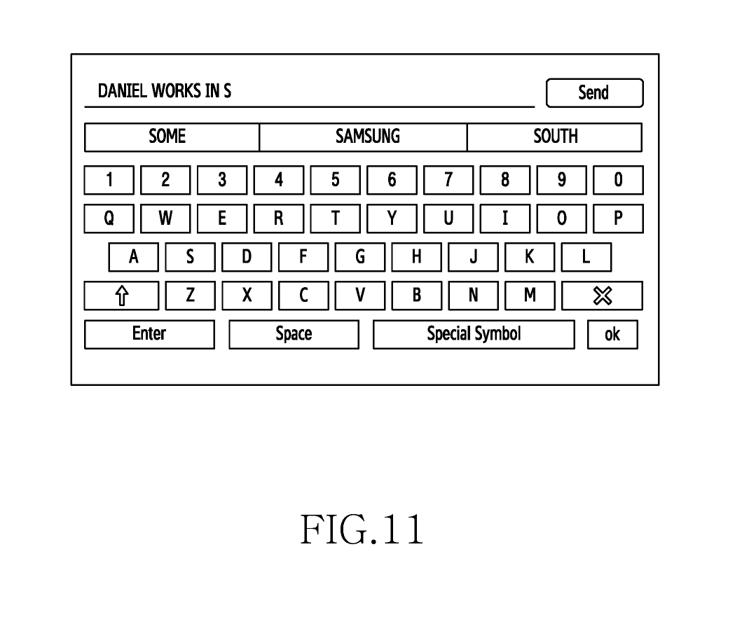

FIG. 11 is an example illustration for word prediction based on the detected input, according to an embodiment of the disclosure.

Referring to FIG. 11, the user enters the text ‘DANIEL WORKS IN S’. The multimodal prediction module 120 analyzes the text to determine nouns in the text detected from the user. The multimodal prediction module 120 identifies semiotics in the language model based on the context of the text detected from the user. Further, the multimodal prediction module 120 identifies whether the information corresponding to the semiotics exist in user profile information and retrieves the information from the user profile information stored in the electronic device 100. Thus, the multimodal prediction module 120 predicts words such as organization names as ‘Samsung’ or ‘Some’ or ‘South,’ as shown in the FIG. 11.

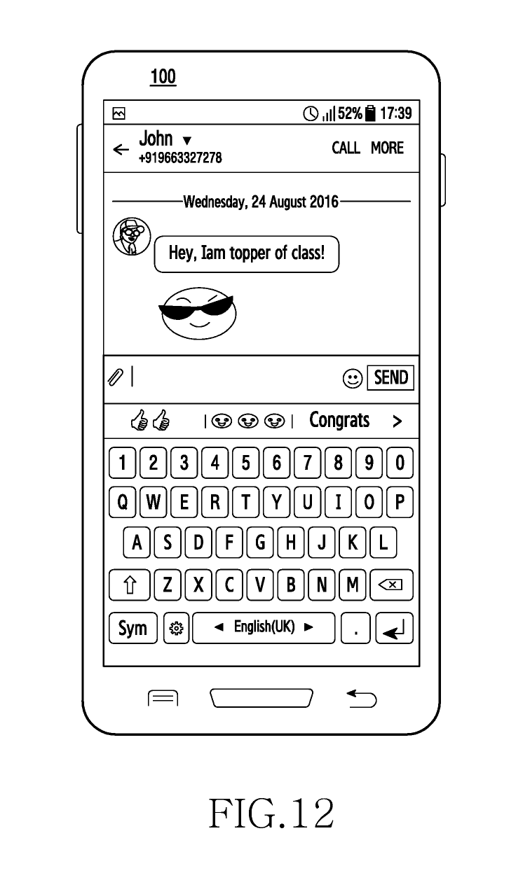

FIG. 12 is an example illustration in which a response to a received message is predicted at the electronic device, according to an embodiment of the disclosure. Referring to FIG. 12, the method may be used to predict responses for a message received at the electronic device. The multimodal prediction module 120 predicts responses by analyzing the message based on the semiotics in the language model. When the message received at the electronic device 100 is ‘Hey I am topper of class.’ The multimodal prediction module 120 provides multimodal predictions based on the context of the message. Thus, the method provides graphical objects, ideograms, non-textual representations, words, characters and symbols as multimodal predictions as the response to the message.

The embodiments disclosed herein can be implemented using at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the disclosure has been shown and described with reference to various embodiments thereof, it will be understood by those skilled in the art that various changes in form and details may be made therein without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for providing context based multimodal predictions in an electronic device, the method comprising:
detecting an input on a touch screen keyboard displayed on a screen of the electronic device;
generating one or more context based multimodal predictions in accordance with the detected input from a language model; and
displaying the one or more context based multimodal predictions in the electronic device.

2. The method of claim 1, wherein the context based multimodal predictions comprises at least one of graphical objects, ideograms, non-textual representations, words, characters or symbols.

3. The method of claim 1, wherein the method further comprises performing one or more actions based on the detected input.

4. The method of claim 3, wherein the one or more actions comprises modifying a layout of the touch screen keyboard for a subsequent input based on the detected input.

5. The method of claim 3, wherein the one or more actions based on the detected input comprises at least one of providing rich text aesthetics based on the context of the detected input, switching a layout of the touch screen keyboard while receiving the input, predicting one or more characters based on the context of the detected input, capitalizing one or more characters or one or more words based on the context of the detected input and recommending one or more suggestions based on the detected input, providing one or more semiotic predictions in response to a received message.

6. The method of claim 1, wherein generating the one or more context based multimodal predictions based on the detected input from the language model comprises:
analyzing the detected input with one or more semiotics in the language model;
extracting the one or more semiotics in the language model in accordance with the detected input;
generating the one more context based multimodal predictions based on the one or more semiotics in the language model; and
feeding the one or more semiotics to the language model after the detected input, for predicting next set of multimodal predictions.

7. The method of claim 6, wherein the language model comprises representations of the multimodal predictions with semiotics data corresponding to a text obtained from a plurality of data sources, wherein the semiotics data is classified based on a context associated with the text.

8. The method of claim 7, wherein each text obtained from the plurality of data sources is represented as semiotics data in the language model for generating the one or more context based multimodal predictions.

9. The method of claim 6, wherein the one or more context based multimodal predictions are prioritized based on the one or more semiotics in the language model.

10. The method of claim 1, the method further comprising: generating the language model containing semiotics data corresponding to a text obtained from a plurality of data sources.

11. An electronic device for providing context based multimodal predictions, the electronic device comprising:
a processor configured to:
detect an input through a touch screen keyboard displayed on a screen of the electronic device;
generate one or more context based multimodal predictions in accordance with the detected input from a language model; and
cause the screen to display the one or more context based multimodal predictions in the electronic device.

12. The electronic device of claim 11, wherein the context based multimodal predictions comprises at least one of graphical objects, ideograms, non-textual representations, words, characters or symbols.

13. The electronic device of claim 11, wherein the processor is further configured to perform one or more actions based on the detected input.

14. The electronic device of claim 13, wherein the one or more actions comprises modifying a layout of the touch screen keyboard for a subsequent input based on the detected input.

15. The electronic device of claim 13, wherein the one or more actions based on the detected input comprises at least one of providing rich text aesthetics based on the context of the detected input, switching a layout of the touch screen keyboard while receiving the input, predicting one or more characters based on the context of the detected input, capitalizing one or more characters or one or more words based on the context of the detected input and recommending one or more suggestions based on the detected input, or providing one or more semiotic predictions in response to a received message.

16. The electronic device of claim 11, wherein the processor is further configured to, in order to generate the one or more context based multimodal predictions in accordance with the detected input from the language model by:
analyze the detected input with one or more semiotics in the language model;
extract the one or more semiotics in the language model in accordance with the detected input;
generate the one more context based multimodal predictions based on the one or more semiotics in the language model; and
feed the one or more semiotics to the language model after the detected input, for predicting next set of multimodal predictions.

17. The electronic device of claim 16, wherein the language model comprises representations of the multimodal predictions with semiotics data corresponding to a text obtained from a plurality of data sources, wherein the semiotics data is classified based on a context associated with the text.

18. The electronic device of claim 16, wherein each text obtained from the plurality of data sources is represented as semiotics data in the language model for generating the one or more context based multimodal predictions.

19. The electronic device of claim 16, the one or more context based multimodal predictions are prioritized in accordance with the detected input based on the one or more semiotics in the language model.

20. The electronic device of claim 11, the electronic device further comprises:
a language model generator configured to:
generate the language model containing semiotics data corresponding to a text obtained from a plurality of data sources.
